(19) United States
(12) Patent Application Publication
(10) Pub. No.: US 2021/0390505 A1
(43) Pub. Date: Dec. 16, 2021

(54) SYSTEM, METHOD, AND APPARATUS PROVIDING A GLOBAL TRADING MARKET-PLACE FOR CHEMICAL PRODUCTS

(71) Applicant: Roman Devinderovich Mataru, Moscow (RU)

(72) Inventor: Roman Devinderovich Mataru, Moscow (RU)

(21) Appl. No.: 17/304,079

(22) Filed: Jun. 14, 2021

Related U.S. Application Data
(60) Provisional application No. 62/705,166, filed on Jun. 14, 2020.

(51) Int. Cl. G06Q 10/08; G06F 16/951

(52) U.S. Cl. CPC G06Q 10/08345; G06F 16/951; G06Q 10/0832; G06Q 10/0833

(57) ABSTRACT

A system, method, and apparatus providing a global trading marketplace for chemical products. The Aensof Cloud Marketplace provides a website connected to cloud computing which offers shared processing resources & data for any chemical industry company & individual to trade online globally.

### CROSS-REFERENCE TO RELATED APPLICATION

This application claims the benefit of priority of U.S. provisional application No. 62/705,166 filed Jun. 14, 2020, the contents of which are herein incorporated by reference.

### BACKGROUND OF THE INVENTION

The present invention relates to online marketplaces and more particularly to online marketplaces for chemical products.

The chemical industry uses an old fashioned and inefficient market for global trade, particularly with respect to small and medium sized producers. While large scale chemical distributors dominate the online marketplace, barriers to entry preclude small to medium sized chemical producers and consumers to participate in a global online marketplace.

As can be seen, there is a need to change the current marketplace by offering an online global trading marketplace for chemical products that facilitates participation by small & medium sized manufacturers, distributors & end users.

### SUMMARY OF THE INVENTION

In one aspect of the present invention, a system for providing a substantial realtime marketplace for chemical products is disclosed. The system includes a server comprising executable software. A data storage device is connected with the server.

A spec sheet database on the data storage device contains a chemical product data sheet, including a chemical product identification, a manufacturer information, one or more chemical characteristics of the chemical product, and one or more transport restrictions for the chemical product. The spec sheet database is updateable by one or more of a manufacturer, a distributor, a dealer, and a seller of the chemical product via a network communication.

A factory database on the data storage device contains a first unique identifier for the one or more of the manufacturer, the distributor, the dealer, and the seller of at least one chemical product in the spec sheet database and a contact information for the one or more of the manufacturer, the distributor, the dealer, and the seller. The factory database is updatable by each the one or more of the manufacturer, the distributor, the dealer, and the seller via the network communication. An end user database on the data storage device contains a second unique identifier for a buyer in the substantial real-time marketplace for chemical products and a contact information of the buyer.

A logistics database on the data storage device contains a third unique identifier for one or more of a logistics entity and a transportation entity, and one or more shipping documents associated with a packaging, a transport, and a delivery of the chemical product. The logistics database is updatable by each logistics entity and transportation entity via the network communication. Computer program code executing on the server is configured to serve a home page, accessible via the network communication.

The home page includes a search engine that is configured to search the spec sheet database responsive to a user query for a selected chemical product or a grade and an application for the chemical product. When the search engine identifies the chemical product in the spec sheet database responsive to the user query, a link to one or more instances of the chemical product located in the spec sheet database is returned to the home page.

A transaction interface is operable upon a user selection of the link to a selected chemical product from one of the one more instances of the chemical product. The transaction interface is operable to complete a transaction for the selected chemical product.

A logistics system is configured provide a real-time shipping rate for the selected chemical product, based on a source location of the selected chemical product, a designated delivery destination of the chemical product, and one or more transport restrictions for the selected chemical product.

In some embodiments, a transport mode selector is operable by the buyer to choose a selected transport mode available for the selected chemical product. A stuffing plan selector may also be operable by the buyer to select a stuffing plan for the selected chemical product within a transport container compatible with the selected transport mode. A rate selector may also be operable by the buyer to select the real-time shipping rate for the selected transport mode.

In some embodiments, a global mapped tracking page is configured to provide the seller and the buyer an order position of the selected chemical product, while in a transport status. The order position may be depicted on a graphical map display.

In some embodiments, a contracts module is configured to create and generate a contract having a plurality of user selectable terms, selected in response to a buyer interaction and a seller interaction within the contracts module.

In some embodiments, a document repository on the data storage device stores the contract. The contract stored in the document repository is accessible by each of the buyer and the seller under the contract.

In other embodiments, a dashboard is configured for a user to access a user profile created by the user and a plurality of documents associated with the user profile contained within the document repository.

In yet other embodiments, the home page may also include a newsroom configured to serve curated content pertaining to the chemical industry. The curated content is organized according to a geographic region selector.

### BRIEF DESCRIPTION OF THE DRAWINGS

FIG. 1 is a representative system architecture for the global trading marketplace for chemical products.

FIG. 2 is a representative web server system architecture for hosting the global trading marketplace for chemical products.

FIG. 3 is a first flow chart indicating user interactions with the global trading marketplace for chemical products.

FIG. 4 is a continuation of the flowchart of FIG. 3.

FIG. 5 is a continuation of the flowcharts of FIGS. 3 and 4.

FIG. 6 is a continuation of the flowcharts of FIGS. 3, 4, and 5.

FIG. 7 illustrates an order tracking screen for the global trading marketplace for chemical products.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, embodiments of the present invention provide a system, method, apparatus, and computer program product that provides a global trading marketplace for chemical products 10. The present invention may be implemented as a single online platform for chemical goods from a plurality of suppliers registered in the system. The main goal of the online platform is to unite many suppliers with customers, dealers, distributors of chemical products in a single trading space. Aspects of the invention allow for fully automated document management throughout the full acquisition lifecycle involved with transactions between a buyer and a seller. The system may be provided via an integrated cloud based online solution.

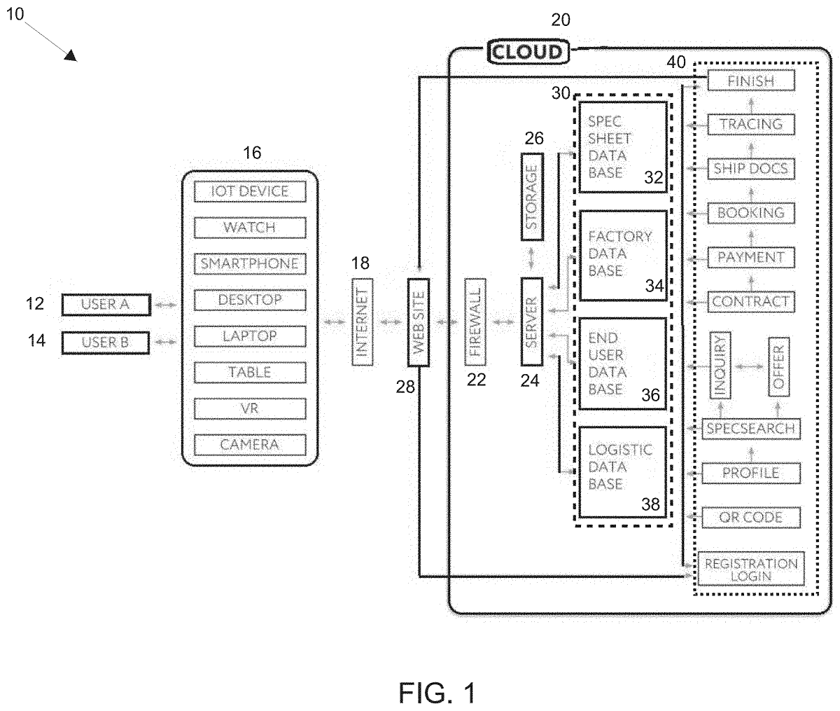

As seen in reference to FIG. 1, aspects of the global trading marketplace for chemical products 10 may include the following elements:

1. User A 12: any one or more of the following: raw material factory, raw material manufacturer, compounding factory, compounding manufacturer, distributor, dealer, reseller, whole seller, sole proprietor & any individual person is a buyer 12.

2. User B 14: any one or all of the following end users: a compounder, a distributor, a dealer, a reseller, a wholesaler, a business entity, a sole proprietor & any individual person or entity that is broadly a seller 14.

3. Connected Device 16: any of a desktop computer, mobile phone, smart phones, tablets, notebooks, game consoles, wristwatches, eBook readers, digital cameras, cars, smart glasses, home appliances & all IOT devices. As well as any device that is web enabled equipped with appropriate connectivity for e.g. (WIFI, 3G, 4G, 5G) and can run on an operating system for example: Linux, iOS, Android, Windows & etc.

4. Internet Connectivity 18: Internet (Port Manteau of interconnected network) is a global system of interconnected computer networks that uses an internet protocol suite, such as (TCP/IP) to link devices worldwide. It is a network of networks that consists of private, public, academic, business and government networks of local to global scope, linked by a broad array of electronics, wireless and optical networking technologies. The internet carries a vast range of information resources and services, such as the interlinked hypertext documents, applications of the world wide web (www), electronic mail, telephony, file sharing & etc.

5. Website 28: Website a collection of web resources such web pages, multimedia content, identified with a common domain name and published on web server. Embodiments of the invention may include the following web pages:

Preferably, all marketplace technologies are built in a cloud based system 20, called Aensof Cloud Marketplace. The Aensof Cloud Marketplace 20 is a secure public cloud platform for hosting, administering and connecting all users 12, 14 within the chemical industry via the cloud 20 from any computing device 16. The Aensof Cloud Marketplace 20 may be located on a secure server 24 through a firewall 22. The server 24 may use a suitable operating system (OS), such as the Linux or Unix family of operating systems. In case of heavy loads, the server 24 is easily scalable, and a cluster of servers 24 may be used to operate the marketplace 20.

Cloud computing 20 is the on-demand availability of computer system resources, data storage, computing power and data center accessible over the Internet. Clouds can be enterprise, hybrid & public. Cloud computing relies to achieve coherence and economies of scale, minimize up-front IT infrastructure costs, application runs faster, improved manageability and less maintenance, and that it enables IT teams to more rapidly adjust resources to meet fluctuating and unpredictable demand.

The following components may be provided within the Aensof Cloud Marketplace framework 20.

Firewall 24: A network security system that monitors and controls incoming and outgoing network traffic based on a predetermined set of security rules. The firewall 24 may include a web application firewall (WAF) 22 that filters, monitors, and blocks http traffic to and from a web application.

Server 24: The server 25 is a computer program or a device that provides functionality 40 for other programs or devices. Types of servers can be database servers 30, file servers, mail servers, print servers, web servers, game servers, application servers and other servers. The database servers 30 include one or more of the following: a spec sheet database 32, a factory database 34, an end user database 36, and a logistical database 38.

The system may include one or more distributed databases. Parts of the database management system may reside on one or more servers. Databases are stored on a storage device connected to servers. Data storage, server storage, NAS, DAS, SAN, back up storage, clusters & etc. may be used to provide & share data access across network.

Spec Sheet Database 32: The spec sheet database 32 contains all product information of chemicals from all over the world. Inducing a full description of chemical products, manufactures information, and chemical characteristics. To this spec sheet database 32, the system sends queries during search engine working when any user is looking for any products. The spec sheet database 32 shares information with all processes internally that it gets from the factory database 34, the end user database 36, and the logistics database 38. The spec sheet database 32 is related to a product and information related to the product. This spec sheet database 32 contains actual products available online that the seller and the buyer can actually trade on the Aensof Cloud Marketplace place 20.

The factory database 34 contains all information of a company, a contact information related to a manufacturer, a distributor, a dealer, and seller users 14 in the Aensof Cloud Marketplace 20. The factory database 34 works together with end user database 36, and the logistics database 38. The factory database 34 works for all eco system of the website 28 and for all stages of documents, diagrams, and figures.

The end user database 36 database contains all information of a company, contacts and relate to buyer 12 users in the system 10. This end user database 36 works together with the factory database 34 and the logistics database 38 for all eco systems of the website and for all stages of documents, diagrams, and figures.

The logistics database 38 contains all information of companies, logistics, transportation, and one or more shipping documents. The logistics database 38 shares and receives information to and from all other databases—spec sheet database—factory database—end user database. Works For all eco system of the website for all stages all documents, diagrams and figures.

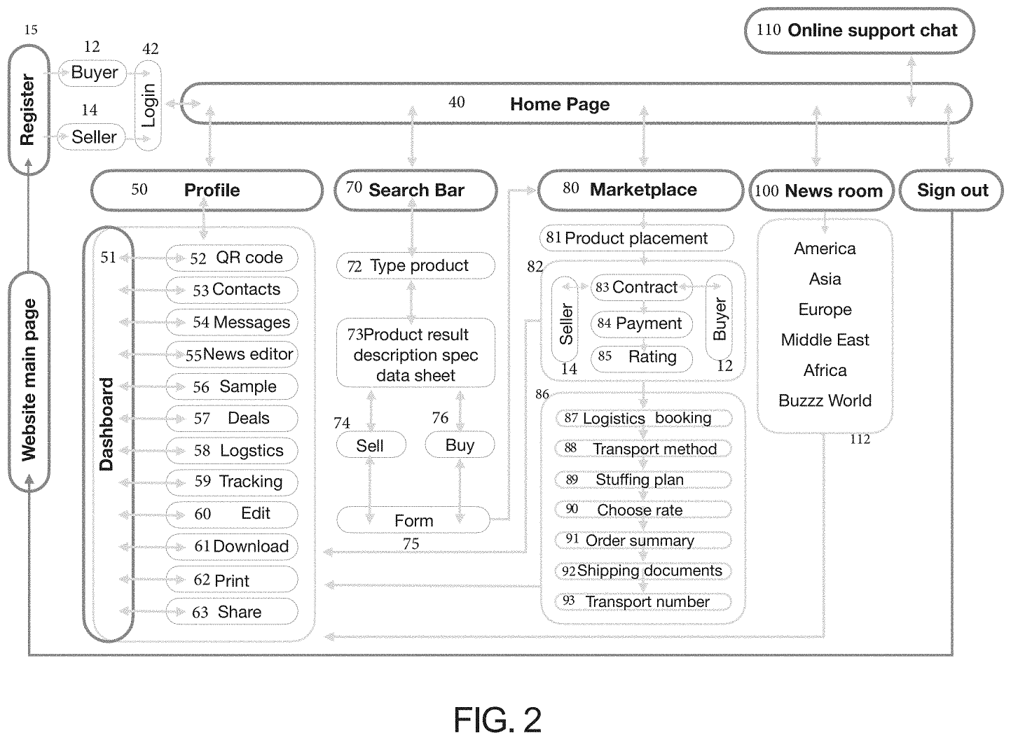

A representative Home Page user interface 40 for the Aensof Cloud Marketplace 20 is shown in reference to FIG. 2. The Home Page 40 may include: an easy sign in with login 42 and password which can be created by registering a username, an email address, a contact number, and a company name. In some embodiments, a user 12, 14 can perform a quick sign up keys via Google or LinkedIn credentials.

The user interface 40 may include a user profile section 50 and a dashboard 51 to perform order management and user actions. This section comprises of user profile 50. The benefit of such layout is that all parts are user friendly, self-explanatory and allow users 12, 14 to work intuitively, in a manner that he is accustomed to in conducting day to day business. Each profile is assigned an ID number 52 and a profile QR code 52. Each user as unique ID number and QR code 52 for identity verification and safety measures. This QR code 52 can be applied along with e-signatures to documents as another safety measure for users 12, 14. A mobile phone camera 16 can be used to scan the QR code 52, by which users can always know the if a document is assigned to a correct users' ownership.

The Home Paige 40 of the marketplace 20 has other sections including: a chemical search engine 70, a selectable market index ticker, a marketplace 80, and a newsroom 100. All are contract displays and can be expanded by user 12, 14. The Home Page 40 is designed to present all the latest marketplace 20 information in compact manner. Users 12, 14 are able to see all important information without the need to look for, or open it separately. Limited scrolling is required to prevent losing focus. This is focus based approach.

In the search bar 70, users 1, 14 can type any generic, grade, application, or any word in the search engine and the search engine 70 returns results from the spec sheet-database 32 with a chemical data sheet 73 including chemical data characteristics of actual manufacturers from all over the world. By clicking on a chemical data sheet link 73, the chemical data sheet 73 expands allowing the user 12, 14 to view the information pertaining to the selected chemical. A control is provided to allow a user to initiate a buy 73 or sell 74 order transaction via a form transaction user interface 75.

Within the marketplace 80, users 14 can experience relevant product placement 81, which may be based on the contents of their profile 50 or data analytics of their transaction history with the marketplace. A transaction interface 82 provides for buyers 12 and sellers 14 a contracts execution module 83 to allow users 12, 14 to prepare and execute a variety of user 12, 14 selected contracts from a selected variety of form contracts.

In a sample transaction with a user selection of a product placement 81 chemical product which has been selected in the previous section with user having available prior to filling in one or more offer terms. This placed product 81 from the seller 14 is uploaded to a cloud server 20 and shown to all other buyers 12 within the global marketplace 10. All interested buyers 12 can choose the buy option and move to next steps for completing an order, which is an automated contract 83 generated between two users, that is, the seller 14 and the buyer 12. Both users 12, 14 can download contracts 83 and have the contract 83 uploaded back unto the cloud 20 and exchanged. The payment system 84 provides for the option for the buyer 12 to pay directly to the seller 14 account, for example, using standard direct bank wire, when the seller 14 shares his banks wire instruction details in the contract 83. After the buyer 12 sends the payment to the seller 14, the transaction interface 82 will allow a bank wire copy, such as swift, to be uploaded and exchanged through the system 10. Both parties 12, 14 must give internal system approval for the deal to considered settled.

As seen in reference to FIG. 10, the system has a built-in messaging system 65 system for the seller 14 and the buyer 12 to communicate for any relevant business topics during order processes and at other times as well. All users 12, 14 have access to an internal business partner phone book for contacts 53. The seller 12 and buyer 14 both are provided each other in their contacts phone book 53 in order to contact each other. This can be done by requesting to be added into the other party's phone book 53. The messages 54 may be via e-mail communications or via a chat functionality that works in a live real time online mode.

FIG. 11 illustrates a post payment process where users can see all inquiries and orders. This is an order management section. By selecting interested order by the buyer next step for logistic booking can be executed by system.

FIG. 12 presents an expanded selected order by the buyer that is put to process for shipment. The user can choose a mode of shipping, for example, sea/land/air. The buyer verifies that all details are correct and can move for forward to next stage of the order placement process.

The Home Page also provides access a logistics module 86 that provides a logistics booking process 87 that allows user 12, 14 selection of a transport method 88 along with selection of a stuffing planning option 89, where the user 12, 14 selects the cargo's placement and position with the actual transport container in which the order is being shipped. This process can help the buyer 12 understand product packing. The seller 14 may receive a buyer 12 acceptance of the selected stuffing plan 89 and the transport method 88.

The logistics module 86 may also a part of the logistics process 86 where the buyer 12 may choose a cost of transportation. The logistics system 86 is configured to provide real time actual confirmed shipping rates 86 from various global logistics companies with full details to transport the actual order in an order summary 91. The rate may be based on a source location for the chemical product, a delivery destination for the chemical product, and one or more transport restrictions applicable to the chemical product.

After the buyer 12 has selected an available rate 86 for the shipment mode and delivery time, the logistics system 86 gives a confirmation for logistics to the buyer. The logistics system 86 sends an invoice to the buyer 12 and the buyer pays using online or bank payment system. The order summary 91 given to the buyer 12 may include details of costs of goods, all transportation costs, and associated charges. This summary 91 is provided upon the buyers 12 chosen destination where this order of delivery is completed within the system. Also, this summary 91 gives all dimensions and weights of the shipment.

The logistics system 86 generates a purchase order and a proforma invoice which is sent to each of the seller 14 and the buyer 11. These documents are also stored in system cloud 20 which can be retrieved from the user's profile dashboard 51, via a deals 57, a logistics 58, or a tracking 59 interface.

The logistics system 86 sends to the seller 14 and the buyer 12, shipping documents 92 which are stored in the cloud 20 logistics database 38 which can be retrieved any time from the user profile dashboard 51, as shipping documents 92, such as order packing list and bill of lading for the order.

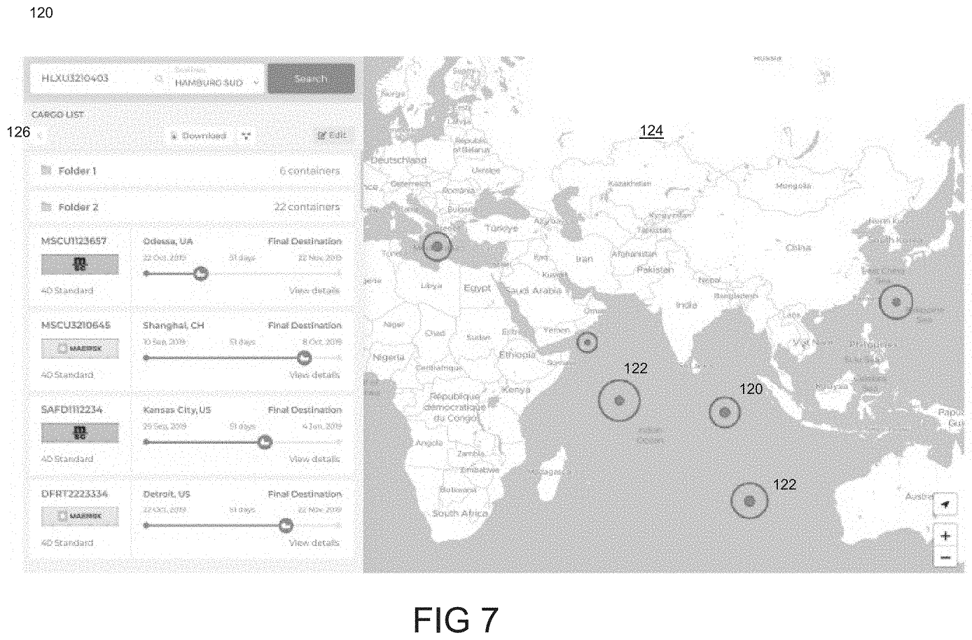

The logistics system 86 may also include a global mapped tracking page 120, such as shown in FIG. 7, which may be accessed via a tracking control 59 in the user dashboard 51. The global mapped tracking page 120 can be used by users to track their order by typing logistics details such as, bill of ladings, Airway bill, trucking CMR, or order number. The seller 14 and the buyer 12 can see and track an actual order position 122 on a map 124. Until the order is delivered, this logistics tracking system 86 will be accessible to see the order delivery movement while in transit. A status pane 126 may display the time and distances will be displayed until full completion of delivery by the one or logistics companies servicing the order. This provides easy very user-friendly way for the customer to help visualize and see delivery status.

The Home Page may also provide access to a newsroom 100 where the seller 14 and the buyer 12 can read curated content containing the latest and relative chemical industry, company, and product news, which is done daily. The newsroom 100 will help the seller 14 and the buyer 12 make better business decisions. Users 12, 14 are also allowed to place news and tweets into this section of newsroom 100. This newsroom 100 works globally. The newsroom 100 is easy to use which divides news into continents or geographic regions 112 so users from any country can quickly access and read the news for a selected geographic region of interest. Short tweets may be placed into a separate section on the newsroom 100 that is called Buzz World, which may be listed within the selectable geographic regions 112.

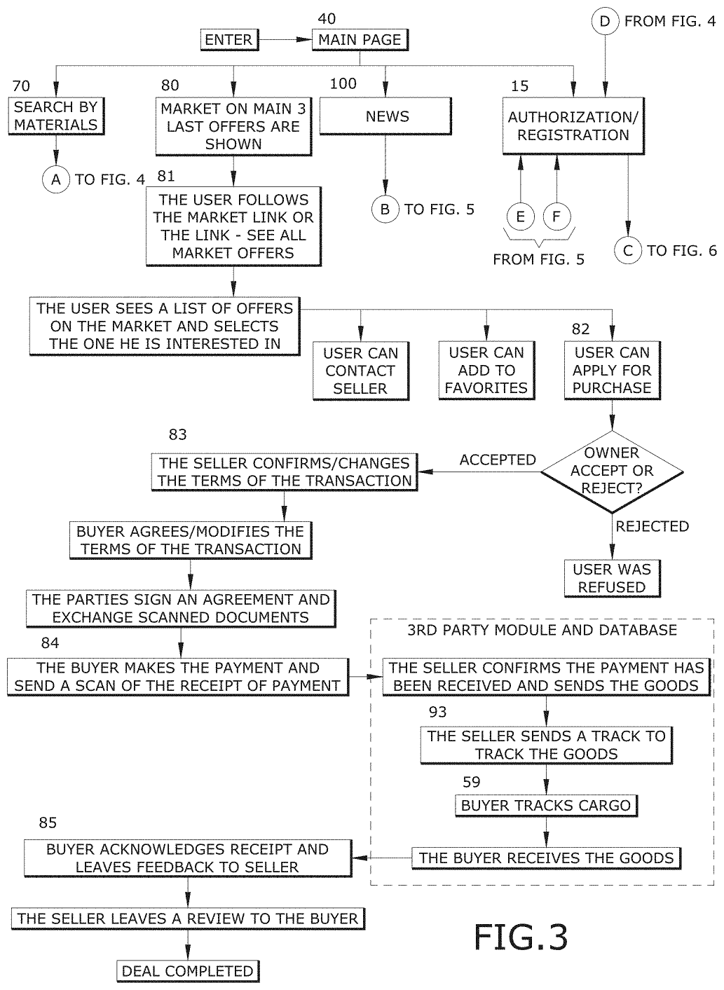

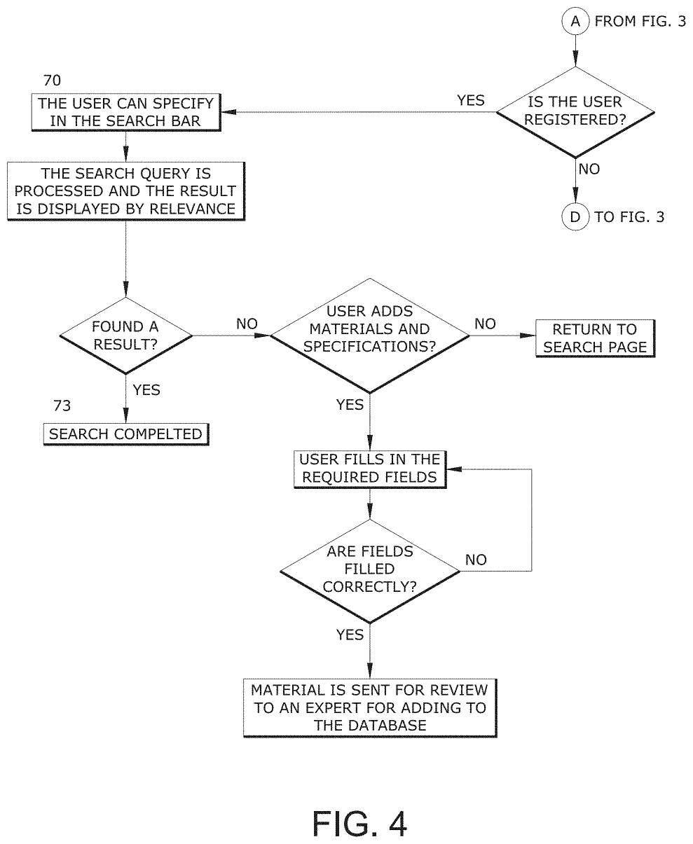

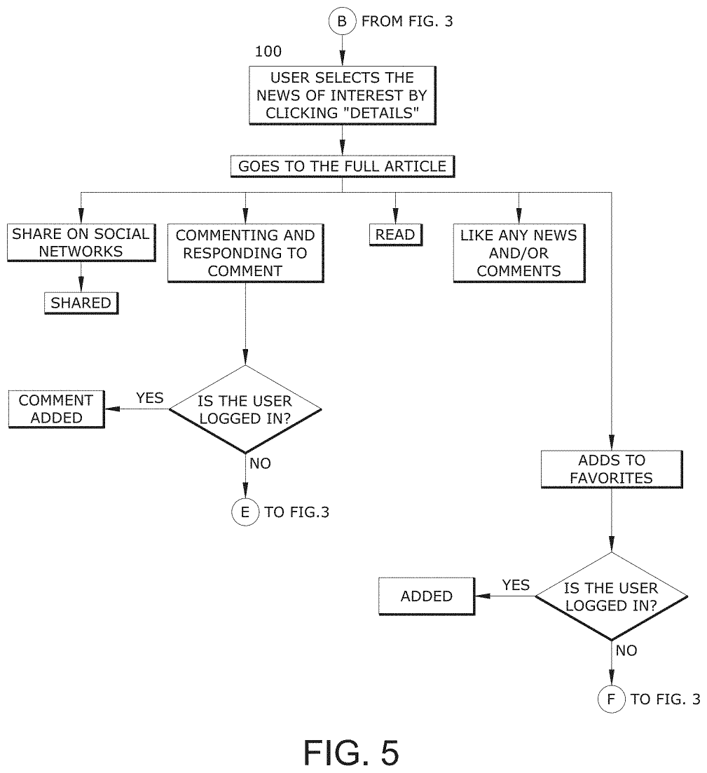

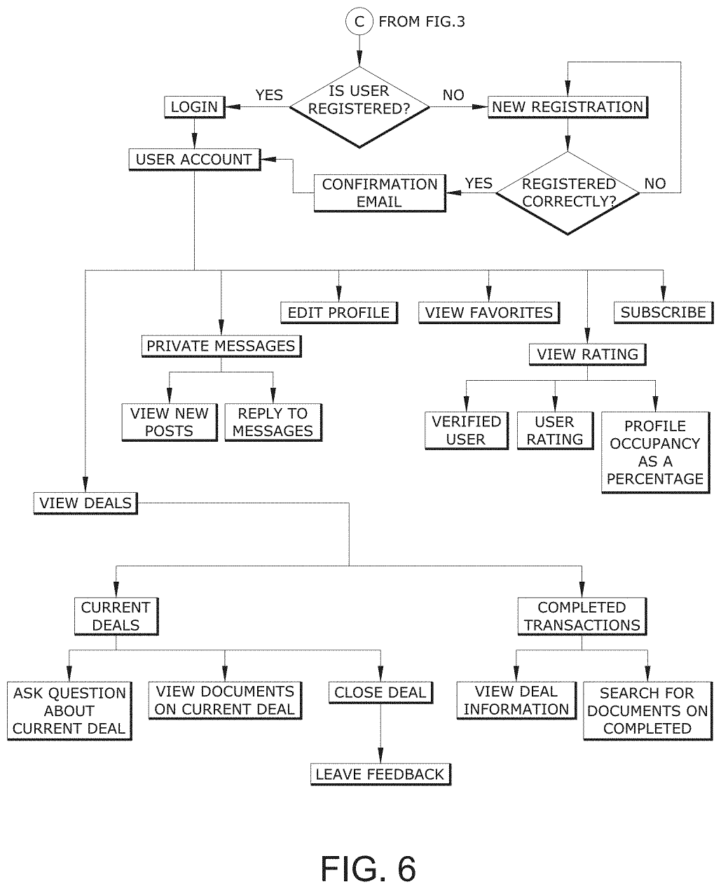

FIGS. 3-6 show a representative flowchart for utilization of the system 20. Registration in the and/or user login; any seller and buyer use online quick registration 15 to register an online profile 50. Alternatively, if they have a registered account, they may login with their account credentials.

Filling in the data in the account (filling out the profile 50) and obtaining a unique id 52 available for viewing through a link or a QR code 52; seller 14 and buyer 12 fill in a standard system form with various company and product related information into the system. This information is saved in the user profile 50 and if required by seller 14 or buyer 12 edited or modified via the dashboard 51, and the edit feature 60.

Placement of goods 80, request for product information or search for goods 70; This part is when seller of buyer wants to sell or buy actual chemical product online. They upload all product information using information that system may have in the spec sheet database 32 or the seller 14 and buyer 12 provide the information themselves, for inclusion with the spec sheet database 32.

Product selection and transaction 82; a seller 14 and buyer 12 choose a product online that is agreed mutually for business terms 83, 84 that both accept online. A contracts module facilitates creation of a contract 83 between both parties 12, 14 exchange goods for payments. The contracts module is configured to generate contracts 83 having a plurality of user selectable terms, selected according to the buyer 12 and seller 14 interactions through the transaction interface 82. Preparation of documents for the transaction: Once the parties have agreed upon the terms, the transactions interface automatically generates electronic contracts and contract documents 83.

Product reservation: After contract and payment, the seller and buyer are both as per contract terms reserve product for this deal.

Payment transaction 84: The payment transaction 84 can be done for product by direct wire transfer to seller 14 by buyer 12 and then logistics system 86 can be done online or bank wire to logistics company by buyer.

Preparation of documents for shipment of goods 86: The shipping documents 92 are generated automatically within the logistics system 86.

Shipment of goods 87-93: Shipment of goods are done by buyer's chosen shipping company that is selected online within the logistics system 86.

Product tracking 59: The product tracing visualization, FIG. 7 is done automatically by the logistics system 86 online.

Confirmation of receipt of goods: As per online tracing both buyers 12 and sellers 14 can see the status of goods online world mapped. Once the order is delivered both parties are notified by the logistics system 86 automatically.

Transaction completion: The transaction is completed considered full by the system and both parties are notified, and each stages status is always available for seller and buyer users, via dashboard 51. The system 10 ensures a contract 83 is signed, a payment 84 is made, a logistics company for delivery must be done 86 and goods are accepted. All stages of a transaction are recorded and both seller 14 and buyer 12 receive a confirmation of transaction stage completion. Once the cargo is delivered, it is considered accepted by buyer. A transaction completion is done, and system stops monitoring this order and finished. Detail records of the completed transaction are accessible via the user's dashboard 51.

When a visitor or user makes a request to a site page: the server reads the code; then processes this code according to the directives written in it.

The system may be implemented with a front end; a back end; and system administration. The system may also be implemented with one more of the following PHP, Java, MySQL, and Phyton programing languages to make an adaptive website suitable to fit a display screen on any device which can be connected using the Internet by connecting to the Aensof Cloud Marketplace. Users can access the Internet and connect to the resource through various devices, such as: an IOT device; a smartwatch; a connected TV, a Smartphone; a Personal computer (PC); a tablet; a camera; a Virtual reality device.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet.

In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for providing a substantial real-time marketplace for chemical products, comprising:
a server comprising executable software;
a data storage device connected with the server;
a spec sheet database on the data storage device containing a chemical product data sheet including a chemical product identification, a manufacturer information, one or more chemical characteristics of the chemical product, and one or more transport restrictions for the chemical product, wherein the spec sheet database is updateable by one or more of a manufacturer, a distributor, a dealer, and a seller of the chemical product via a network communication;
a factory database on the data storage device containing an a first unique identifier for the one or more of the manufacturer, the distributor, the dealer, and the seller of at least one chemical product in the spec sheet database and a contact information for the one or more of the manufacture, the distributor, the dealer, and the seller, wherein the factory database is updatable by each the one or more of the manufacture, the distributor, the dealer, and the seller via the network communication;
an end user database on the data storage device containing a second unique identifier for a buyer in the substantial real-time marketplace for chemical products and a contact information of the buyer; and
a logistics database on the data storage device containing a third unique identifier for one or more of a logistics entity and a transportation entity, and one or more shipping documents associated with a packaging, a transport, and a delivery of the chemical product; wherein the logistics database is updatable by each logistics entity and transportation entity via the network communication;
computer program code executing on the server configured to serve a home page, accessible via the network communication, the home page comprising:
a search engine configured to search the spec sheet database responsive to a user query for a selected chemical product or a grade and an application for the chemical product, wherein when the search engine identifies the chemical product in the spec sheet database responsive to the user query, returning a link to one or more instances of the chemical product located in the spec sheet database;
a transaction interface operable upon a user selection of the link to a selected chemical product from one of the one more instances of the chemical product, the transaction interface operable to complete a transaction for the selected chemical product; and
a logistics system configured provide a real-time shipping rate for the selected chemical product, based on a source location of the selected chemical product, a designated delivery destination of the chemical product, and one or more transport restrictions for the selected chemical product.

2. The system of claim 1, the logistics system further comprising:
a transport mode selector operable by the buyer to choose a selected transport mode available for the selected chemical product.

3. The system of claim 2, the logistics system further comprising:
a stuffing plan selector operable by the buyer to select a stuffing plan for the selected chemical product within a transport container compatible with the selected transport mode.

4. The system of claim 3, the logistics system further comprising:
a rate selector operable by the buyer to select the real-time shipping rate for the selected transport mode.

5. The system of claim 4, the logistics system further comprising:
a global mapped tracking page configured to provide the seller and the buyer an order position of the selected chemical product, while in a transport status.

6. The system of claim 5, wherein the order position is depicted on a graphical map display.

7. The system of claim 1, the transaction interface further comprising:
a contracts module configured to create and generate a contract having a plurality of user selectable terms, selected in response to a buyer interaction and a seller interaction with the contracts module.

8. The system of claim 7, further comprising:
a document repository on the data storage device to store the contract, wherein the contract stored in document repository is accessible by each of the buyer and the seller under the contract.

9. The system of claim 8, the home page further comprising:
a dashboard configured for a user to access a user profile created by the user and a plurality of documents associated with the user profile contained within the document repository.

10. The system of claim 7, the home page further comprising:
a newsroom configured to serve curated content pertaining to the chemical industry.

11. The system of claim 10, wherein the curated content is organized according to a geographic region selector.
